(19) United States
(12) Patent Application Publication
(10) Pub. No.: US 2004/0258324 A1
(43) Pub. Date: Dec. 23, 2004

(54) Method for dynamic contrast enhancement by area gray-level detection

(76) Inventors: Kuan Liang, Hsin-Chun (TW); Chao-Chee Ku, Hsin-Chu (TW)

Correspondence Address: ANTHONY R BARKUME, 20 GATEWAY LANE, MANORVILLE, NY, 11949, US

(21) Appl. No.: 10/757,049

(22) Filed: Jan. 14, 2004

(30) Foreign Application Priority Data
Jun. 20, 2003 (TW) 092116702

(51) Int. Cl. G06K 9/40; G06K 9/00; G06K 9/38

(52) U.S. Cl. 382/274; 382/270; 382/169

(57) ABSTRACT

A method for dynamic contrast enhancement by area gray-level detection with an image comprising steps of: transferring color space of said image from color space of RGB to that with brightness Y; making a brightness distribution histogram based on brightness of said image to get a corresponding relation between a gray level value and a count; dividing the whole brightness distribution into even brightness distribution areas by gray level value, and calculating each amount of counts of each brightness distribution area; according to said amount of counts, deciding a transfer curve to do brightness histogram equalization to the image for forming a new image with enhanced contrast.

### FIELD OF THE INVENTION

The present invention is related to a method for dynamic contrast enhancement of an image, and more particularly to that functioning by area gray-level detection. The feature of the method lies in dividing brightness distribution of an image into even brightness distribution areas equally, and calculating the amount of counts in each brightness distribution area. Further, according to the ratio of these amounts above, we can decide a brightness transfer curve of the image, so as to do brightness histogram equalization to the image.

### BACKGROUND OF THE INVENTION

Some images look so blur and obscure when being showed on the screen that we can hardly tell them because of contrast. In order to improve the quality of this kind of images, the process of dynamic contrast enhancement is used to obtain clear images. A current and better method for dynamic contrast enhancement is to analyze brightness distribution of each of images, that is, a so-called analysis of brightness distribution. According to the analysis of brightness distribution of an image, the process of histogram equalization can adjust the contrast of an image and redistribute the histogram so that the contrast of the whole image is enhanced.

FIG. 1 shows the flow chart of conventional method for contrast enhancement. The steps of implementation are as follows:

11: Input an image.

12: Transfer color space of the image from R, G, B into Y, Cr, Cb (or Y, U, V, or Y, Pb, Pr). Brightness Y has 256 gray levels (8-bit).

13: Make a brightness distribution histogram. FIG. 2 shows pixels of each gray level value of the image by counts. (Calculate by 8-bit. And, there are 256 gray levels totally, from 0˜255.)

14: Decide boundary points, XL and XH, in the whole brightness distribution of FIG. 2 according to a fixed ratio of gray level (ex. 10%). For example, the counts of area 0˜XL and that of area XH˜255 take 10% of the whole area respectively.

15: Proceed the process of brightness histogram equalization to the image. FIG. 3 shows the transfer curves of conventional brightness histogram equalization for enhancing contrast, where Yin (X-axis) and Yout (Y-axis) represent brightness of the image inputted and that with enhanced contrast respectively by 256 gray levels (0˜255). With regard to the two transfer curves, the dotted line represents Yout=Yin (slope=1); the solid line represents the transfer curve of contrast enhancement. Moreover, on Yin-axis, the area 0˜ XL and the area XH˜255 (each of them takes a fixed ratio of the amounts of counts on the axis of gray level value, such as 10%) both are set for Yout/YinL<1 (slope<1) to lower the brightness in the two areas; the area XL˜XH is set for Yout/Yin>1 (slope>1) to enhance the brightness in this area.

16: Output the image with enhanced contrast.

Although the conventional technique can help us achieve the goal of enhancing contrast in each image, but it may be practically difficult to implement the technique by hardware. In the conventional technique, the gray level values of both XL and XH on Yin-axis are selected respectively by the fixed ratio of the amounts of counts on the axis of gray level value. Also, these values are neither constants nor necessarily the power of 2. Therefore, we need a divider when calculating gray level value on Yout-axis—it'll produce the effect of raising costs, time of calculation and difficulties of hardware implementation. That's why, when talking to practical functioning of the conventional technique, we think it dose need improving.

### SUMMARY OF THE INVENTION

An objective of the present invention is to provide a method for dynamic contrast enhancement by area gray-level detection to meet the requirement above.

Another objective of the present invention is to divide brightness distribution of an image into even brightness distribution areas equally, and calculate the amount of counts in each brightness distribution area.

Another objective of the present invention is to decide a brightness transfer curve of the image, so as to do brightness histogram equalization to the image according to the ratio of these amounts.

Another objective of the present invention is to replace the way of calculating by multiplication and division with that of looking up a table. Therefore, the loading of calculation is very low (only looking up a table and calculating by addition), which further helps us lower the cost of hardware and the time of calculation.

Another objective of the present invention is to make the dynamic contrast enhancement very adaptive. Brightness of each gray level value can be lowered or enhanced appropriately with original brightness attributes of an image, so wrong contrast enhancement will hardly happen.

According to the present invention, the present invention proposes the method of dynamic contrast enhancement by area gray-level detection. Now we provide an image to proceed the following steps:

Transfer color space of the image from color space of RGB to that of brightness Y;

Make a brightness distribution histogram based on brightness of the image to get a corresponding relation between a gray level value and a count;

Divide the whole brightness distribution into even brightness distribution areas by gray level value, and calculate each amount of counts of each brightness distribution area.

According to these amounts of counts, decide a transfer curve to do brightness histogram equalization to the image for forming a new image with enhanced contrast.

In accordance with one aspect of the present invention, the color space with brightness Y is YCrCb.

In accordance with one aspect of the present invention, the color space with brightness Y is YPbPr.

In accordance with one aspect of the present invention, the color space with brightness Y is YUV.

In accordance with one aspect of the present invention, counts here mean the quantity of pixels of a gray level value in the image.

In accordance with one aspect of the present invention, the range of gray level value is from 0 to 255.

In accordance with one aspect of the present invention, there are 4 brightness distribution areas.

In accordance with one aspect of the present invention, the steps of deciding a transfer curve based on the amounts of counts are:

Let that each brightness distribution area is respectively named A1,A2, . . . ,Aₙ₋₁,Aₙ and each amount of counts of A1,A2, . . . ,Aₙ₋₁,Aₙ, is respectively named Q1,Q2, . . . ,Qₙ₋₁,Qₙ, where n means the number of each brightness distribution area;

Let H1=Q1+Q2, H2=Q3+Q4, . . . , H_{n/2}=Qₙ₋₁+Qₙ; regulate Yout(1)=Yin(1)*Q1/H1, Yout(2)=Yin(2)*Q3/H2, . . . , Yout(n/2)=Yin(n/2)*Qₙ₋₁/H_{n/}2, where Yin(1) is the gray level value of the boundary point of A1 and A2; Yin(2) is the gray level value of the boundary point of A3 and A4; . . . ; Yin(n/2) is the gray level value of the boundary point of Aₙ−1 and Aₙ. And, Yout (1), Yout(2), . . . ,Yout(n/2) are gray level values of the image with enhanced contrast;

Get the transfer curve by the corresponding relation between Yin(1) and Yout(1), Yin(2) and Yout(2), . . . , Yin(n/2) and Yout(n/2).

In accordance with one aspect of the present invention, we move average based on Yout(1), Yout(2), . . . , Yout(n/2) of multiple images, that is, to get the transfer curve by the corresponding relation between the average of Yout(1) and Yin(1), and between the average of Yout(2) and Yin(2), . . . , and between the average of Yout(n/2) and Yin(n/2).

In accordance with one aspect of the present invention, there're four successive images.

The present invention is better understood upon consideration of the detailed description below, in conjunction with the accompanying drawings. As will become readily apparent to those skilled in the art from the following description, there is shown and described an embodiment of this invention simply by way of illustration of the best mode to carry out the invention. As will be realized, the invention is capable of other embodiments and its several details are capable of modifications in various obvious aspects, all without departing from the scope of the invention. Accordingly, the drawings and detailed description will be regarded as illustrative in nature and not as restrictive.

### BRIEF DESCRIPTION OF THE DRAWINGS

The novel features believed characteristic of the invention are set forth in the appended claims. The invention itself, however, as well as a preferred mode of use, and further objects and advantages thereof, will best be understood by reference to the following detailed description of an illustrative embodiments when read in conjunction with the accompanying drawings, wherein:

FIG. 1 shows the conventional flow chart of contrast enhancement;

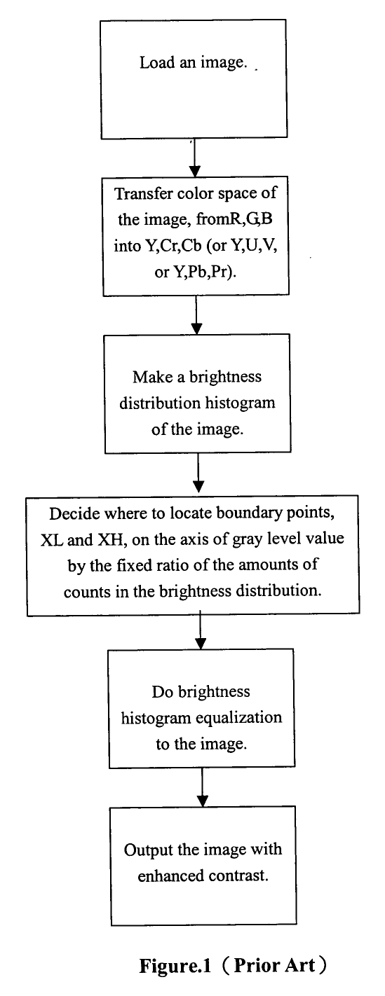

FIG. 2 shows brightness distribution of an image in conventional method of contrast enhancement;

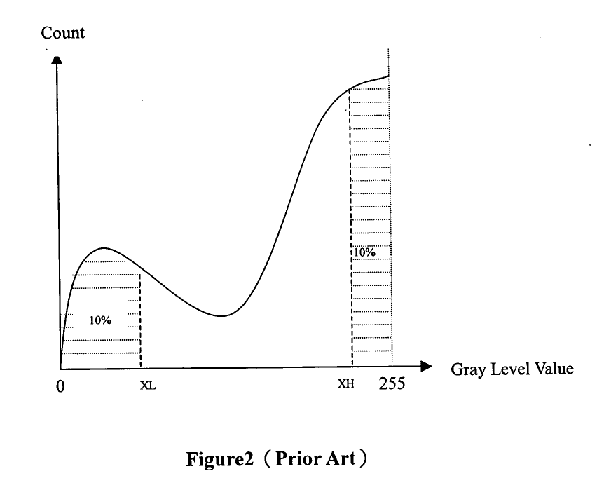

FIG. 3 shows brightness histogram equalization of an image in the conventional method of contrast enhancement;

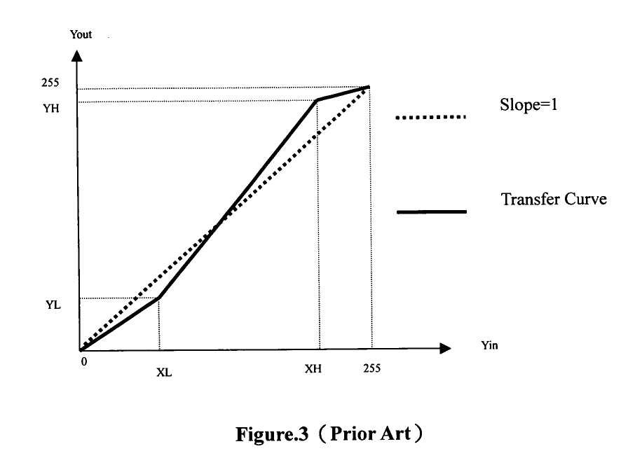

FIG. 4 shows the flow chart of dynamic contrast enhancement by area gray-level detection according to the present invention;

FIG. 5 shows the brightness distribution of an image according to the present invention;

FIG. 6 shows the brightness histogram equalization of an image according to the present invention; and

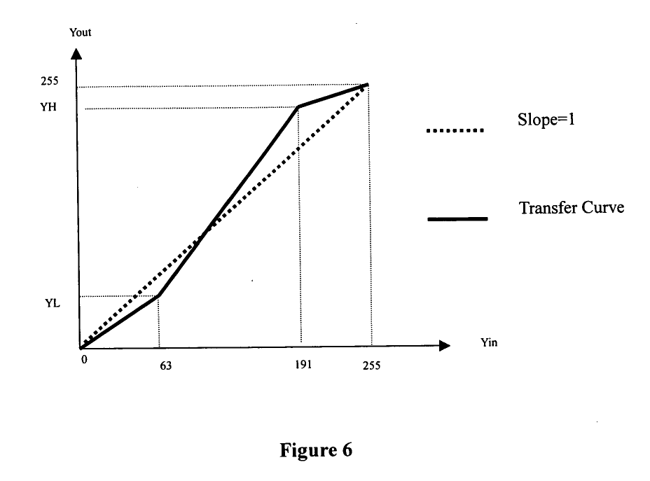

FIG. 7 shows the result of implementing dynamic contrast enhancement by area gray-level detection according to the present invention.

### DETAILED DESCRIPTION OF THE PREFERRED EMBODIMENT

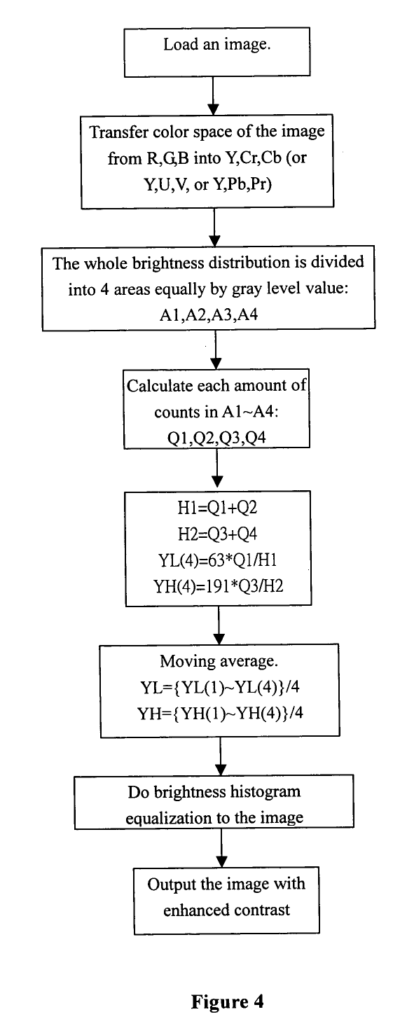

FIG. 4 shows the flow chart of present invention for dynamic contrast enhancement.

The steps of implementation are as follows:

41: Input an image.

42: Transfer color space of the image from R, G, B into Y, Cb, Cr (or Y, U, V or Y, Pb, Pr). Brightness Y has 256 gray levels (8-bit).

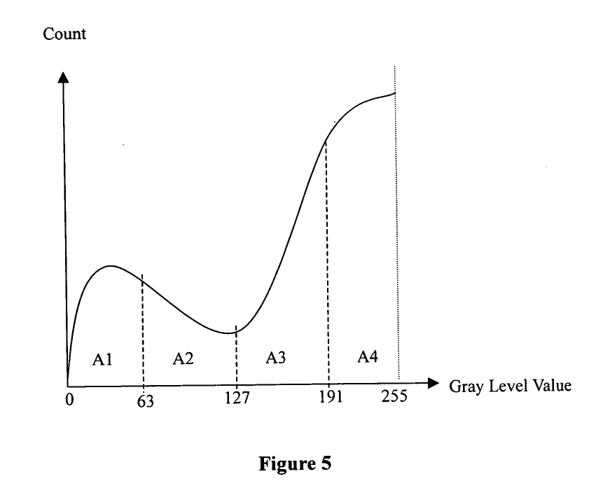

43: Please refer to FIG. 5. Make a brightness distribution histogram of the image to identify pixels of each gray level value in the image by counts. In the preferred embodiment of the present invention, the whole brightness distribution is divided into four areas equally by gray level value: A1(0˜63), A2(64˜127), A3(1281191), and A4(192˜255).

44: Use four counters to calculate the amount of counts of each gray level value in each area from A1 to A4. These amounts are Q1, Q2, Q3 and Q4, respectively.

45: Regulate that H1=Q1+Q2, H2=Q3+Q4, YL(4)=63*QlI/H1, YH(4)=191*Q3/H2. In this formula, 63 means the gray level value of the boundary point of A1 and A2; 191 means the gray level value of the boundary point of A3 and A4. This step, practically, can be executed by looking up a table, instead of multiplication and division. Besides, the method of contrast enhancement can help us to decide how many brightness distribution areas will be divided without worrying if hardware can run or not. Due to the reason, the gray level value of each boundary point can remain constant. As long as we always remember to save results after calculating all kinds of ratios in advance and then look up a table according to Q1, H1 and Q3, H2, we can get YL(4) and YH(4) quickly without complicated calculation.

46: Moving average. Sometimes, doing dynamic contrast enhancement to one of the continuously sliding images will result in abrupt variation. If this problem occurs, average YL (●) and YH (●) of previous images. In the example of the present invention, we average four values, so the boundary points of Yout are YL={YL(1)˜YL(4)}/4 and YH={YH(1)˜YH(4)}/4.

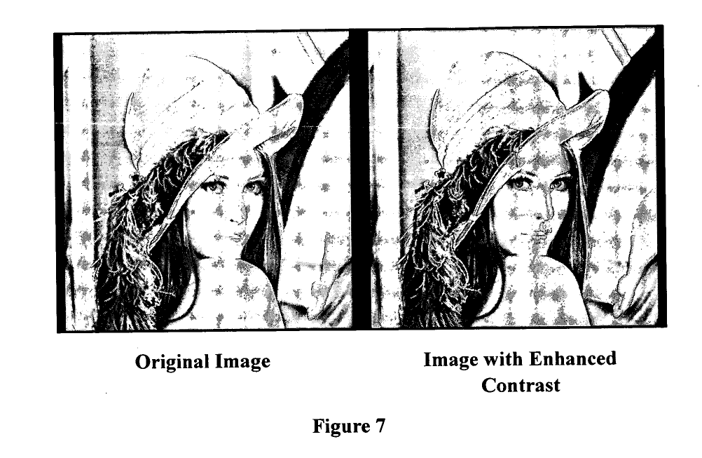

47: Do brightness histogram equalization of the image. According to the gray level values of the boundary points (63 and 191) of brightness Yin of the image inputted and YL and YH of the image with enhanced contrast, we can decide a transfer curve as FIG. 7 shows so as to do brightness histogram equalization of the image.

48: Output the image with enhanced contrast.

FIG. 7 shows the result of implementing dynamic contrast enhancement by area gray-level detection in the present invention. The left figure shows the original image; the right one shows the image with enhanced contrast. If we compare the two figures and check the effect of contrast, we can find obviously the image which has been enhanced contrast has great effect of contrast of brightness and darkness and great tridimensional impression. However, the preferred embodiment of the present invention is just one of the examples of implementing the method. In the image of the preferred embodiment, the gray levels of brightness, the way to divide brightness distribution areas and the quantity of images for moving average all can be adjusted to meet the requirements for practical functioning. Moreover, we divide the whole brightness distribution of the image into only four brightness distribution areas, because we don't know if hardware for implementing the method can run or not. But if we want to get an exquisite image with sharp contrast or to process more brightness distribution areas with high contrast, we can divide the whole brightness distribution of the image into eight or more areas for further controlling contrast in each brightness distribution area.

To sum up, the present invention is to reform the conventional technique. The method proposed is to divide brightness distribution of an image into even brightness distribution areas, calculate each amount of counts in each brightness distribution area, decide a transfer curve of the image by the ratio of the amounts and finally do brightness histogram equalization to the image. The improvement the present invention achieves lies in: the method of dynamic contrast enhancement by area gray-level detection has not only a very low loading of calculation (only looking up a table and calculating by addition), but also better adaptation, compared with the conventional technique. The first advantage (a very low loading of calculation) can effectively lower the cost of hardware and the time of calculation. The second advantage (better adaptation) can help to lower and enhance brightness of each gray level value appropriately with original brightness attributes of an image, so wrong contrast enhancement will hardly happen, and an exquisite image with sharp contrast and great three-dimensional impression will come out.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for dynamic contrast enhancement by area gray-level detection with an image comprising steps of:
transferring color space of said image from color space of RGB to that with brightness Y;
making a brightness distribution histogram based on brightness of said image to get a corresponding relation between a gray level value and a count;
dividing the whole brightness distribution into even brightness distribution areas by gray level value, and calculating each amount of counts of each brightness distribution area;
according to said amount of counts, deciding a transfer curve to do brightness histogram equalization to the image for forming a new image with enhanced contrast.

2. The method according to claim 1 wherein said color space with brightness Y is YCrCb.

3. The method according to claim 1 wherein said color space with brightness Y is YPbPr.

4. The method according to claim 1 wherein In accordance with one aspect of the present invention, the color space with brightness Y is YUV.

5. The method according to claim 1 wherein said counts here mean the quantity of pixels of a gray level value in said image.

6. The method according to claim 1 wherein the range of said gray level value is from 0 to 255.

7. The method according to claim 1 wherein the steps of deciding said transfer curve based on the amounts of counts are:
making that each brightness distribution area is respectively named A1,A2, . . . ,Aₙ₋₁Aₙ, and each amount of counts of A1,A2, . . . ,Aₙ₋₁,Aₙ, is respectively named Q1,Q2, . . . ,Qₙ₋₁,Qₙ, where n means the number of each brightness distribution area;
making H1=Q1+Q2, H2=Q3+Q4, . . . , H_{n/2}=Qₙ₋₁+Qₙ;
making Yout(1)=Yin(1)*Q1/H1, Yout(2)=Yin(2)*Q3/H2, . . . ,Yout(n/2)=Yin(n/2)*Qₙ₋₁/H_{n/2}, where Yin(1) is said gray level value of the boundary points of A1 and A2; Yin(2) is said gray level value of the boundary points of A3 and A4; . . . ; Yin(n/2) is said gray level value of the boundary point of Aₙ₋₁, and An. And, Yout (1), Yout(2), . . . ,Yout(n/2) are gray level values of the image with enhanced contrast;
getting said transfer curve by the corresponding relation between Yin(1) and Yout(1), Yin(2) and Yout(2), . . . , Yin(n/2) and Yout(n/2).

8. The method according to claim 1 wherein a move average is calculated by Yout(1), Yout(2), . . . , Yout(n/2) of multiple images.

9. The method according to claim 1 wherein said images include four successive images.
